(19) United States
(12) Patent Application Publication
(10) Pub. No.: US 2012/0112568 A1
(43) Pub. Date: May 10, 2012

(54) COOLING SYSTEM FOR AN ELECTRIC MACHINE SYSTEM INCLUDING AN ALTERNATING CURRENT (AC) ELECTRIC MACHINE HAVING AN INTEGRATED SWITCH ASSEMBLY

(75) Inventors: Bradley D. Chamberlin, Pendleton, IN (US); Alex Creviston, Muncie, IN (US)

(73) Assignee: REMY TECHNOLOGIES, L.L.C., Pendleton, IN (US)

(21) Appl. No.: 12/939,332

(22) Filed: Nov. 4, 2010

(51) Int. Cl. H02K 9/19; H02P 27/06

(52) U.S. Cl. 310/54; 318/139

(57) ABSTRACT

An electric machine system includes an alternating current (AC) electric machine. The AC machine includes a machine housing having a machine portion and a switch portion. A stator is fixedly mounted in the machine portion of the machine housing and a rotor rotatably mounted relative to the stator. A switch assembly is arranged within the switch portion of the machine housing and electrically connected to the stator. A direct current (DC) power source is electrically connected to the stator through the switch assembly. A cooling system is fluidly connected to the AC electric machine. The cooling system directs a flow of coolant onto the switch assembly in the switch portion of the machine housing, and onto at least one of the stator and the rotor in the machine portion of the machine housing.

### BACKGROUND OF THE INVENTION

Exemplary embodiments pertain to the art of electric machines and, more particularly, to a cooling system for an alternating current electric machine having an integrated switch assembly.

Conventional electric motor systems, such as those used in automotive, agricultural, and other heavy duty applications where electric and hybrid motors are employed, include an electric motor operatively coupled to an inverter through high voltage cabling. A typical inverter includes a controller portion and a multi-phase power switching portion. The multi-phase power switching portion includes various high voltage components such as insulated gate bipolar transistors (IGBTs), metal oxide semiconductor field effect transistors (mosfets), rectifiers, capacitors, inductors, high voltage wiring and the like. The inverter is electrically connected to an engine control module, a high voltage battery, and the electric motor. The connections between the inverter and the battery, and the inverter and the electric motor, require high voltage cabling. In addition, the heat generated by operation of the high voltage components requires cooling. As such, conventional inverters are also typically connected to a dedicated cooling system. Cooling systems for inverters include a fluid coolant such as oil, water, air or other media that can absorb and retain heat.

### BRIEF DESCRIPTION OF THE INVENTION

Disclosed is an electric machine system including an alternating current (AC) electric motor. The AC machine includes a machine housing having a machine portion and a switch portion. A stator is fixedly mounted in the machine portion of the machine housing and a rotor rotatably mounted relative to the stator. A switch assembly is arranged within the switch portion of the machine housing and electrically connected to the stator. A direct current (DC) power source is electrically connected to the stator through the switch assembly. A cooling system is fluidly connected to the AC electric machine. The cooling system directs a flow of coolant in thermally conductive proximity to the switch assembly in the switch portion of the machine housing, and onto at least one of the stator and the rotor in the machine portion of the machine housing.

Also disclosed is an alternating current (AC) electric machine. The AC electric machine includes a machine housing having a machine portion and an switch portion, a stator fixedly mounted in the machine portion of the machine housing, a rotor rotatably mounted relative to the stator, an switch assembly is arranged within the switch portion of the machine housing and electrically connected to the stator, and a cooling system fluidly connected to the AC electric machine. The cooling system directs a flow of coolant in thermally conductive proximity to the switch assembly in the switch portion of the machine housing, and onto at least one of the stator and the rotor in the machine portion of the machine housing.

### BRIEF DESCRIPTION OF THE DRAWINGS

The following descriptions should not be considered limiting in any way. With reference to the accompanying drawings, like elements are numbered alike:

FIG. 1 depicts an electric machine system in accordance with an exemplary embodiment; and

FIG. 2 depicts an alternating current (AC) electric machine of the electric machine system of FIG. 1.

### DETAILED DESCRIPTION OF THE INVENTION

A detailed description of one or more embodiments of the disclosed apparatus and method are presented herein by way of exemplification and not limitation with reference to the Figures.

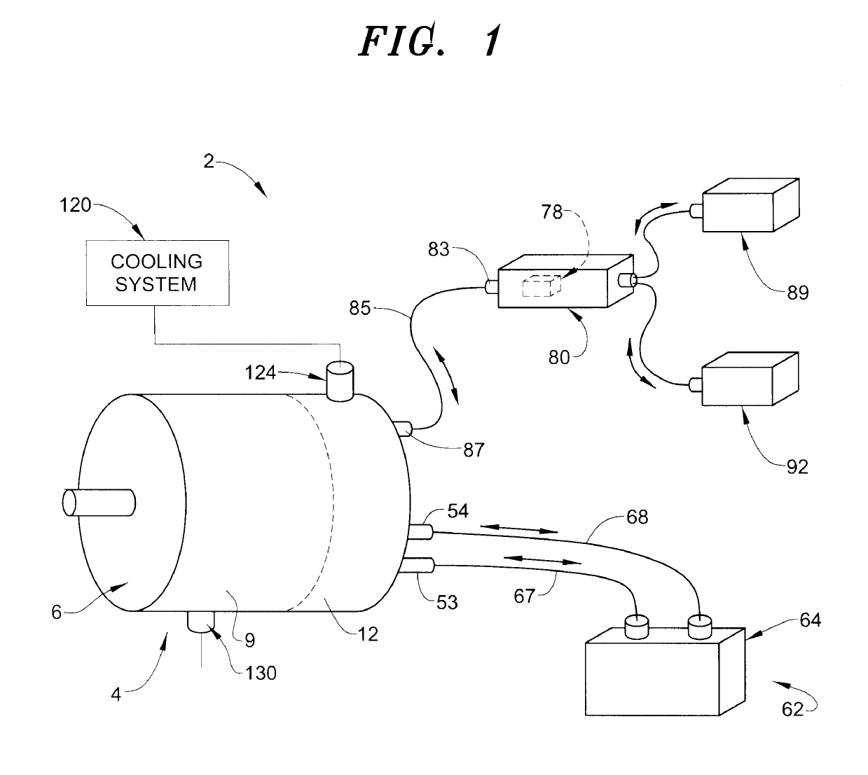

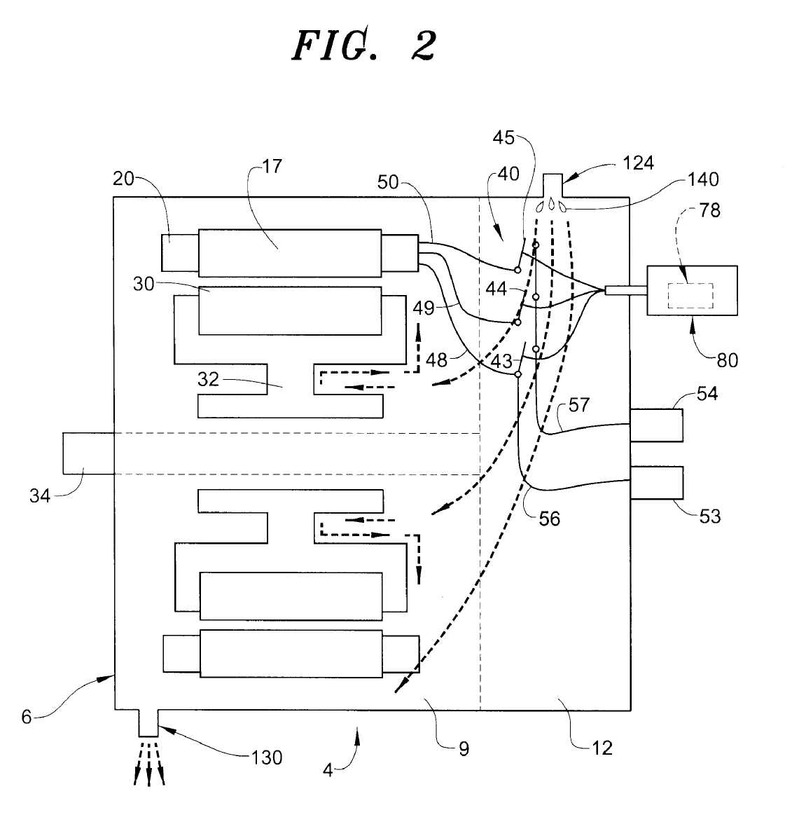

With reference to FIGS. 1 and 2, an electric machine system constructed in accordance with an exemplary embodiment is indicated generally at 2. Electric machine system 2 includes an alternating current (AC) electric machine shown in the form of an electric motor 4 having a machine housing 6. Machine housing 6 includes a machine portion 9 and a switch portion 12. In the exemplary embodiment shown, machine portion 9 includes a stator assembly 17 having a plurality of windings 20. Windings 20 define a number of phases for AC electric motor 4. More specifically, AC electric motor 4 constitutes a multi-phase AC electric motor. Machine portion 9 is also shown to include a rotor assembly 30 having a rotor hub 32 that is operatively coupled to an output shaft 34. At this point, it should be understood that the electric machine in accordance with the exemplary embodiment could take the form of an electric motor, i.e., an electric machine provided with an electric current input to produce a mechanical output or an electric generator, i.e., an electric machine provided with a mechanical input that is transformed into an electrical current.

In accordance with an exemplary embodiment, switch portion 12 of machine housing 6 includes a switch assembly 40 that is electrically connected to stator assembly 17. Switch assembly 40 includes a first switch member 43 that is electrically connected to a first phase winding (not separately labeled) of stator assembly 17 by a first high voltage conductor 48, a second switch member 44 that is electrically connected to a second phase winding (not separately labeled) of stator assembly 17 by a second high voltage conductor 49, and a third switch member 45 that is electrically connected to a third phase winding (not separately labeled) of stator assembly 17 by a third high voltage electric conductor 50. Switch members 43-45 take the form of insulated gate bipolar transistors (IGBTs), metal oxide semiconductor field effect transistors (mosfets), rectifiers, capacitors, inductors and the like. At this point it should be understood that while only three switch members are shown, the number, location and type of switch members can vary. “High voltage” should be understood to mean any voltage shared between electric AC motor 4 and a power supply. In accordance with one exemplary aspect, “high voltage” is voltage in a range of between about 100 volts to about 1000 volts. Voltage should be understood to include voltage supplied by switch assembly 40 to the electric machine when operated in a motor mode or passed to switch assembly 40 when the electric machine is operated in a generator mode. In general, voltage should be understood to include energy that is exchanged between the electric machine and switch assembly 40 resulting in a transformation of energy between a mechanical and electrical state. Switch assembly 40 is electrically connected to first and second power terminals 53 and 54 provided on machine housing 6. Power terminals 53 and 54 are electrically connected to switch members 43-45 by first and second high voltage conductors 56 and 57. In accordance with the exemplary embodiment, conductors 48-50 and 56-57 are arranged within machine housing 6. Power terminals 53 and 54 are also electrically connected to a direct current (DC) power source 62, shown in the form of a high voltage battery 64 having a voltage rating above about 100 volts, by high voltage cables 67 and 68 respectively. Thus, in the exemplary embodiment shown, AC electric motor 4 is provided power by DC power source 62.

Electric machine system 2 is shown to include a controller 78 that is electrically connected to switch assembly 40. Controller 78 electrically activates (opens/closes) switch members 43-45 to transform DC electrical current from DC power source 62 to a multi-phase AC electric current that is used to power AC electric motor 4. Controller 78 is arranged within a controller housing 80 that is remote from AC electric motor 4. Controller housing 80 includes a control terminal 83 that electrically connects controller 78 to AC electric motor 4. More specifically, controller 78 is linked to switch assembly 40 by a low voltage cable 85 that extends between control terminal 83 and a control terminal element 87 provided on machine housing 6. “Low voltage” should be understood to mean voltage shared between controller 98 and switch assembly 40 employed to achieve a change in state, e.g., open/close, switch members 47-49. In accordance with one aspect of the exemplary embodiment, “low voltage” constitutes voltage in a range of between greater than about 0 volts and about 99 volts. Electric machine system 2 also includes a motor control module 89 electrically connected to controller 78. Motor control module 89 establishes a desired operational speed for AC electric motor 4. Controller 78 is also shown linked to additional control inputs 92 could also include accessory control modules, or other vehicle operational parameters such as torque, speed, power and the like.

Electric machine system 2 is further shown to include a cooling system 120. Cooling system 120 includes a coolant input port 124 and a coolant output port 130 that are fluidly connected to machine housing 6. Coolant input port 124 directs a coolant 140, such as air, oil, water, a glycol mixture, or the like toward switch portion 12 of AC electric motor 4. Coolant 140 is passed in thermally conductive proximity to switch assembly 40 to absorb heat from each switch member 43-45. Coolant 140 then flows toward machine portion 9 of machine housing 6. Coolant 140 flows onto rotor hub 32 and onto rotor laminations (not separately labeled). Alternatively, coolant 140 could indirectly absorb heat from machine portion 9 such as by passing coolant 140 in a thermally conductive proximity to the rotor laminations (not separately labeled) and or stator assembly 17 through a coolant jacket (not shown). Coolant 140 absorbs additional heat from rotor assembly 32 and stator assembly 17 before passing from machine housing 6 through coolant output port 130. Coolant 140 then passes through a heat exchanger to removed the heat and is reintroduced to AC electric machine 4. Alternatively, coolant 140 may be passed to other devices.

At this point it should be understood, that the exemplary embodiments eliminates the need for multiple cooling systems by incorporating a cooling system that directs a coolant onto both the switch assembly and motor components of the AC electric machine. In the exemplary embodiment cooling requirements for the switches are satisfied by the same coolant used to cool machine portions, e.g., stator, and rotor, of the electric machine. In this manner, control for the switch assembly may be mounted remotely from switch members themselves.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine system comprising:
an alternating current (AC) electric machine including a machine housing having a machine portion and a switch portion, a stator fixedly mounted in the machine portion of the machine housing, a rotor rotatably mounted relative to the stator, and an switch assembly arranged within the switch portion of the machine housing and electrically connected to the stator;
a direct current power source electrically connected to the stator through the switch assembly; and
a cooling system fluidly connected to the AC electric machine, the cooling system directing a flow of coolant in thermally conductive proximity to the switch assembly in the switch portion of the machine housing, and in thermally conductive proximity to at least one of the stator and the rotor in the machine portion of the machine housing.

2. The electric machine system according to claim 1, wherein the cooling system includes a coolant input port fluidly connected to the switch portion of the machine housing and a coolant output port fluidly connected to the machine portion of the machine housing.

3. The electric machine system according to claim 1, wherein the coolant comprises oil.

4. The electric machine system according to claim 1, wherein the coolant includes glycol.

5. The electric machine system according to claim 1, wherein the AC electric machine is a multi-phase electric motor.

6. The electric machine system according to claim 5, wherein the switch assembly includes a first switch member that establishes a first phase of the multi-phase electric motor, a second switch member that establishes a second phase of the multi-phase electric motor, and a third switch member that establishes a third phase of the multi-phase electric motor.

7. The electric machine system according to claim 1, further comprising:
a controller arranged with a controller housing, the controller housing being remote from the machine housing, wherein the controller is electrically connected to the switch assembly through a low voltage electric cable.

8. The electric machine system according to claim 1, further comprising:
a motor control module electrically connected to the controller.

9. The electric machine system according to claim 1, wherein the DC power source is a battery.

10. The electric machine according to claim 9, wherein the battery is a high voltage battery having a voltage rating above 100 volts.

11. An alternating current (AC) electric machine comprising:
a machine housing having a machine portion and a switch portion;
a stator fixedly mounted in the machine portion of the machine housing;
a rotor rotatably mounted relative to the stator;
an switch assembly arranged within the switch portion of the machine housing and electrically connected to the stator; and
a cooling system fluidly connected to the AC electric machine, the cooling system directing a flow of coolant onto the plurality of switch members in the switch portion of the machine housing, and onto at least one of the stator and the rotor in the machine portion of the machine housing.

12. The AC electric machine according to claim 11, wherein the cooling system includes a coolant input port fluidly connected to the switch portion of the machine housing and a coolant output port fluidly connected to the machine portion of the machine housing.

13. The AC electric machine according to claim 11, wherein the coolant comprises oil.

14. The AC electric machine according to claim 11, wherein the coolant includes glycol.

15. The AC electric machine according to claim 11, wherein the AC electric machine is a multi-phase electric motor.

16. The AC electric machine according to claim 15, wherein the switch assembly includes a first switch member that establishes a first phase of the multi-phase electric motor, a second switch member that establishes a second phase of the multi-phase electric motor, and a third switch member that establishes a third phase of the multi-phase electric motor.

17. The AC electric machine according to claim 11, further comprising: a controller arranged with a controller housing, the controller housing being remote from the machine housing, wherein the controller is electrically connected to the switch assembly through a low voltage electric cable.

18. The AC electric machine according to claim 17, further comprising: a direct current (DC) power source electrically connected to the stator through the switch assembly.

19. The AC electric machine according to claim 18, wherein the DC power source is a high voltage battery having a voltage rating above about 100 volts.

20. The AC electric machine according to claim 11, further comprising: a motor control module electrically connected to the controller.
